(19) United States
(12) Patent Application Publication
(10) Pub. No.: US 2005/0067453 A1
(43) Pub. Date: Mar. 31, 2005

(54) Nailer having adjustable trigger

(76) Inventor: Wen-Sheng Huang, Taichung (TW)

Correspondence Address: Wen-Sheng Huang, 58, MA YUAN WEST ST., TAICHUNG, TW

(21) Appl. No.: 10/676,438

(22) Filed: Sep. 29, 2003

(51) Int. Cl. B27F 7/17

(52) U.S. Cl. 227/8; 227/130

(57) ABSTRACT

A nailer includes a main body provided with a contact switch, an adjusting member movably mounted on the main body, a trigger mounted on the adjusting member to move therewith, and a stepped press plate mounted on the trigger to move therewith. Thus, the trigger and the press plate are moved by the adjusting member, so that the press plate is disposed at different locations to press the contact switch of the main body with different pressing actions so as to perform a single or successive trigger action by the principle of air compression, such that the trigger has an adjustable function.

### BACKGROUND OF THE INVENTION

1. Field of the Invention

The present invention relates to a nailer, and more particularly to a nailer having an adjustable trigger.

2. Description of the Related Art

A conventional nailer comprises a main body, a head portion, a safety portion, a control switch, a contact switch, and a trigger. The control switch is formed with a stepped groove with two different depths so as to change the position of the control switch, so that when the trigger is pressed by the user's finger, the contact switch of the main body is triggered by the trigger to perform a single or successive trigger action by changing the position of the control switch.

However, the position of the stepped groove of the control switch is changed by a rotation portion exposed outward from the nailer, so that the position of the stepped groove of the control switch is easily changed due to unintentional touch during the operation process, thereby causing danger to the user. In addition, the control switch has to co-operate with the safety portion, so that the adjusting structure of the trigger is not available for nailers without a safety portion.

### SUMMARY OF THE INVENTION

The primary objective of the present invention is to provide a nailer having an adjustable trigger.

Another objective of the present invention is to provide a nailer, wherein the trigger and the press plate are moved by the adjusting member, so that the press plate is disposed at different locations to press the contact switch of the main body with different pressing actions so as to perform a single or successive trigger action.

A further objective of the present invention is to provide a nailer, wherein the adjustment is performed by adjusting the position of the trigger, so that the adjusting structure of the trigger is available for nailers with or without a safety switch.

In accordance with the present invention, there is provided a nailer, comprising:
a main body provided with a contact switch;
an adjusting member movably mounted on the main body;
a trigger mounted on the adjusting member to move therewith; and
a stepped press plate mounted on the trigger to move therewith and including a first portion and a second portion, wherein:
the trigger is moved between a first position where the first portion of the press plate is rested on the contact switch of the main body and a second position where the second portion of the press plate is rested on the contact switch of the main body.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a nailer in accordance with the preferred embodiment of the present invention;

FIG. 2 is an exploded perspective view of the nailer as shown in FIG. 1;

FIG. 3 is a locally side plan cross-sectional view of the nailer as shown in FIG. 1;

FIG. 4 is a locally plan cross-sectional view of the nailer as shown in FIG. 1;

FIG. 5 is a schematic operational view of the nailer as shown in FIG. 4;

FIG. 6 is a schematic plan operational view of the nailer as shown in FIG. 2; and

FIG. 7 is a schematic operational view of the nailer as shown in FIG. 6.

### DETAILED DESCRIPTION OF THE INVENTION

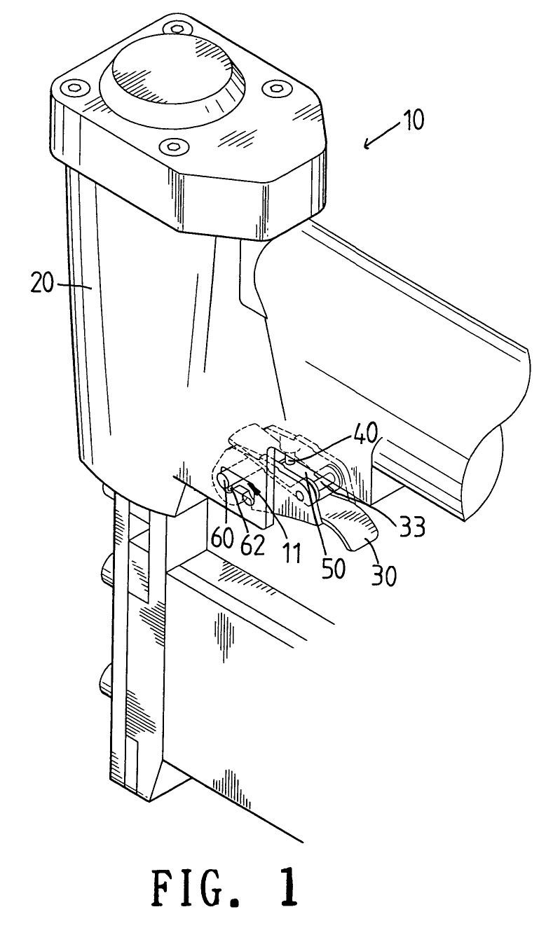

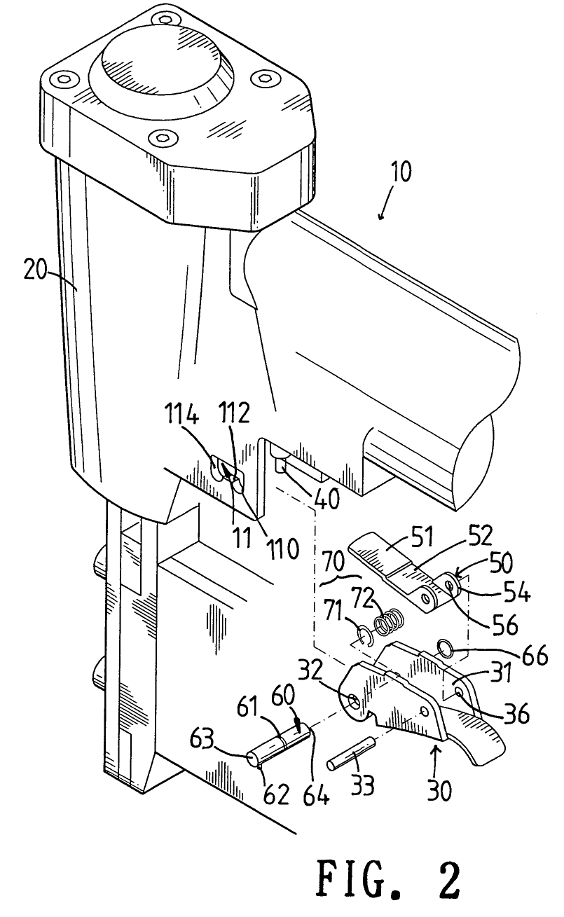

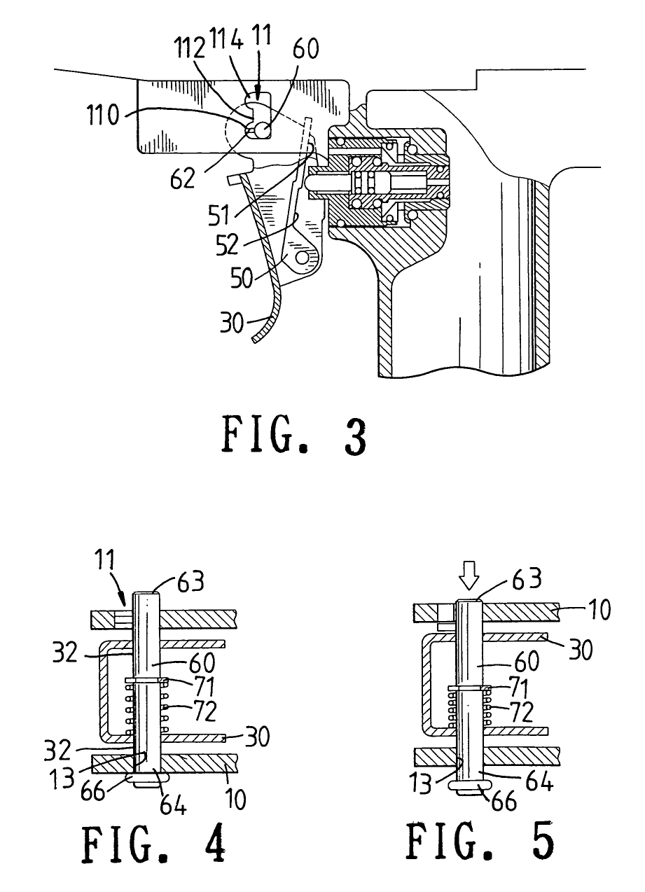

Referring to the drawings and initially to FIGS. 1-3, a nailer in accordance with the preferred embodiment of the present invention comprises a main body 10 provided with a contact switch 40, an adjusting member 60 movably mounted on the main body 10, a trigger 30 mounted on the adjusting member 60 to move therewith, and a stepped press plate 50 mounted on the trigger 30 to move therewith and including a first portion 51 and a second portion 52.

In such a manner, the trigger 30 is moved between a first position where the first portion 51 of the press plate 50 is rested on the contact switch 40 of the main body 10 and a second position where the second portion 52 of the press plate 50 is rested on the contact switch 40 of the main body 10.

The main body 10 has an end provided with a head portion 20. The main body 10 has a first side wall formed with an adjusting slot 11 and a second side wall formed with a through hole 13 (see FIG. 4). The contact switch 40 of the main body 10 is located adjacent to the adjusting slot 11.

The adjusting slot 11 of the main body 10 has a first end formed with a first positioning recess 110 and a second end formed with a second positioning recess 114. The adjusting slot 11 of the main body 10 has a mediate portion formed with a protruding shoulder 112 located between the first positioning recess 110 and the second positioning recess 114.

The trigger 30 has an inside formed with a receiving chamber 31. The trigger 30 has two opposite side walls each having a first end formed with a circular through hole 32 and a second formed with a pivot hole 36.

The press plate 50 is received in the receiving chamber 31 of the trigger 30. Preferably, the press plate 50 is substantially Z-shaped, so that the first portion 51 and the second portion 52 of the press plate 50 are disposed at different locations. The first portion 51 of the press plate 50 is located adjacent to the contact switch 40 of the main body 10. The second portion 52 of the press plate 50 is provided with two pivot ears 54 each formed with a pivot hole 56.

The nailer further comprises a pivot shaft 33 extended through the pivot holes 36 of the trigger 30 and the pivot holes 56 of the press plate 50, so that the press plate 50 is pivotally mounted on the trigger 30.

The adjusting member 60 having a rod shape is extended through the adjusting slot 11 of the first side wall of the main body 10, the through holes 32 of the trigger 30 and the through hole 13 of the second side wall of the main body 10. The adjusting member 60 has a first end 63 slidably mounted in the adjusting slot 11 of the main body 10 and a second end 64 protruding outward from the through hole 13 of the main body 10. The first end 63 of the adjusting member 60 has a periphery formed with a locking block 62 rested on a wall of the adjusting slot 11 of the main body 10. The nailer further comprises a retaining ring 66 secured on the second end 64 of the adjusting member 60 and rested on the second side wall of the main body 10.

The nailer further comprises a restoring device 70 mounted between the trigger 30 and the adjusting member 60. The adjusting member 60 has a mediate portion formed with an annular groove 61, and the restoring device 70 includes a substantially C-shaped snap ring 71 secured in the annular groove 61 of the adjusting member 60, and a spring 72 mounted on the adjusting member 60 and having a first end urged on one side wall of the trigger 30 and a second end urged on the snap ring 71 for pressing the adjusting member 60 toward the adjusting slot 11 of the main body 10.

In operation, referring to FIGS. 1-7, the locking block 62 of the adjusting member 60 is initially locked in the first positioning recess 110 of the adjusting slot 11 of the main body 10 by the elastic force of the spring 72, so that the first portion 51 of the press plate 50 is rested on the contact switch 40 of the main body 10 as shown in FIG. 6. Thus, when the trigger 30 is pressed by the user's finger, the contact switch 40 of the main body 10 is triggered by the first portion 51 of the press plate 50 to perform a single trigger action.

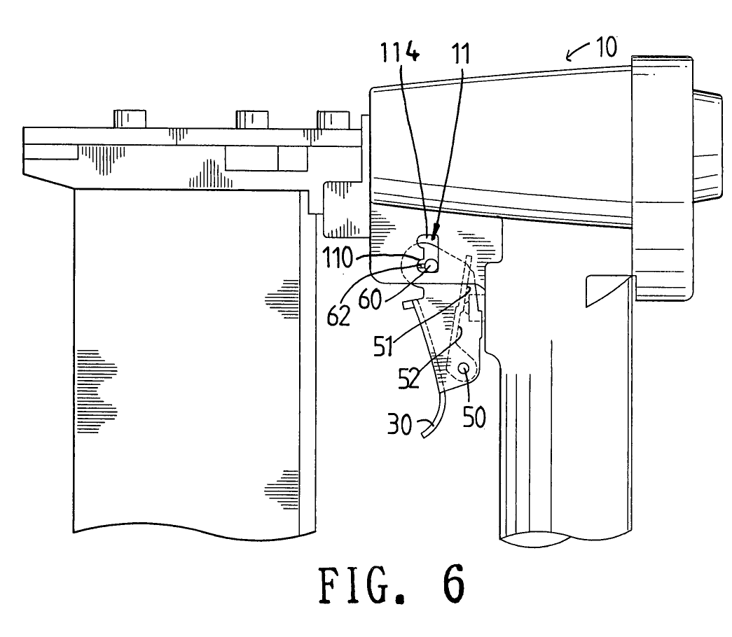

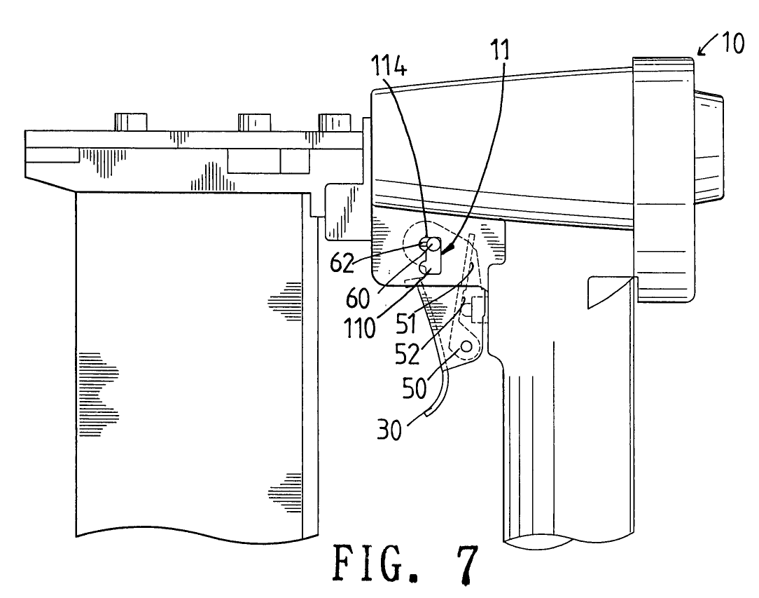

Alternatively, the first end 63 of the adjusting member 60 is pressed to move from the position as shown in FIG. 4 to the position as shown in FIG. 5 to compress the spring 72, thereby detaching the locking block 62 of the adjusting member 60 from the first positioning recess 110 of the adjusting slot 11 of the main body 10, so that the adjusting member 60 can be moved in the adjusting slot 11 of the main body 10 from the position as shown in FIG. 6 to the position as shown in FIG. 7 where the adjusting member 60 aligns with the second positioning recess 114 of the adjusting slot 11 of the main body 10. After the force applied on the first end 63 of the adjusting member 60 is removed, the adjusting member 60 is pressed toward the adjusting slot 11 of the main body 10 by the restoring force of the spring 72, so that the locking block 62 of the adjusting member 60 is locked in the second positioning recess 114 of the adjusting slot 11 of the main body 10 as shown in FIG. 7. At this time, the trigger 30 and the press plate 50 are moved by the adjusting member 60 to the position as shown in FIG. 7, so that the second portion 52 of the press plate 50 is rested on the contact switch 40 of the main body 10. Thus, when the trigger 30 is pressed by the user's finger, the contact switch 40 of the main body 10 is triggered by the second portion 52 of the press plate 50 to perform a successive trigger action.

Accordingly, the trigger 30 and the press plate 50 are moved by the adjusting member 60, so that the press plate 50 is disposed at different locations to press the contact switch 40 of the main body 10 with different pressing actions so as to perform a single or successive trigger action by the principle of air compression, such that the trigger 30 has an adjustable function. In addition, the adjustment is performed by adjusting the position of the trigger 30, so that the adjusting structure of the trigger 30 is available for nailers with or without a safety switch.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A nailer, comprising:
a main body provided with a contact switch;
an adjusting member movably mounted on the main body;
a trigger mounted on the adjusting member to move therewith; and
a stepped press plate mounted on the trigger to move therewith and including a first portion and a second portion, wherein:
the trigger is moved between a first position where the first portion of the press plate is rested on the contact switch of the main body and a second position where the second portion of the press plate is rested on the contact switch of the main body.

2. The nailer in accordance with claim 1, wherein the main body has a first side wall formed with an adjusting slot having a first end formed with a first positioning recess and a second end formed with a second positioning recess.

3. The nailer in accordance with claim 2, wherein the adjusting slot of the main body has a mediate portion formed with a protruding shoulder located between the first positioning recess and the second positioning recess.

4. The nailer in accordance with claim 2, wherein the adjusting member has a first end slidably mounted in the adjusting slot of the main body and having a periphery formed with a locking block locked in either one of the first positioning recess and the second positioning recess of the adjusting slot of the main body.

5. The nailer in accordance with claim 1, wherein the trigger has two opposite side walls each having a first end formed with a through hole, the main body has a second side wall formed with a through hole, and the adjusting member is extended through the adjusting slot of the first side wall of the main body, the through holes of the trigger and the through hole of the second side wall of the main body.

6. The nailer in accordance with claim 1, wherein the trigger has an inside formed with a receiving chamber, and the press plate is received in the receiving chamber of the trigger.

7. The nailer in accordance with claim 1, wherein the press plate is substantially Z-shaped.

8. The nailer in accordance with claim 1, wherein the first portion and the second portion of the press plate are disposed at different locations.

9. The nailer in accordance with claim 1, wherein the first portion of the press plate is located adjacent to the contact switch of the main body.

10. The nailer in accordance with claim 1, wherein the trigger two opposite side walls each having a second formed with a pivot hole, the second portion of the press plate is provided with two pivot ears each formed with a pivot hole, and the nailer further comprises a pivot shaft extended through the pivot holes of the trigger and the pivot holes of the press plate, so that the press plate is pivotally mounted on the trigger.

11. The nailer in accordance with claim 1, wherein the adjusting member has a rod shape.

12. The nailer in accordance with claim 1, wherein the contact switch of the main body is located adjacent to the adjusting slot.

13. The nailer in accordance with claim 5, wherein the adjusting member has a second end protruding outward from the through hole of the main body.

14. The nailer in accordance with claim 13, further comprising a retaining ring secured on the second end of the adjusting member and rested on the second side wall of the main body.

15. The nailer in accordance with claim 1, further comprising a restoring device mounted between the trigger and the adjusting member.

16. The nailer in accordance with claim 15, wherein the adjusting member has a mediate portion formed with an annular groove, and the restoring device includes a substantially C-shaped snap ring secured in the annular groove of the adjusting member, and a spring mounted on the adjusting member and having a first end urged on one side wall of the trigger and a second end urged on the snap ring for pressing the adjusting member toward the adjusting slot of the main body.
